(19) United States
(12) Patent Application Publication
(10) Pub. No.: US 2010/0266999 A1
(43) Pub. Date: Oct. 21, 2010

(54) USER-DIRECTED, CONTEXT-BASED LEARNING SYSTEMS AND METHODS

(76) Inventors: Sari R. Follansbee, Cambridge, MA (US); Elaine L. Lindy, Newton, MA (US)

Correspondence Address: RISSMAN HENDRICKS & OLIVERIO, LLP, 100 Cambridge Street, Suite 2101, BOSTON, MA, 02114, US

(21) Appl. No.: 12/427,744

(22) Filed: Apr. 21, 2009

(51) Int. Cl. G09B 7/00

(52) U.S. Cl. 434/322

(57) ABSTRACT

A user-directed, machine-implemented learning system may include at least one processor, a memory including instructions for the processor, and a bus for providing communication between the processor and the memory. The memory may further include instructions for the processor, including instructions for presenting a plurality of selectable categories to a user, receiving an input from a user selecting one of the plurality of categories, and retrieving at least one data item with a learning target used in context in the data item. The data item corresponds to the selected category, and the use context explains the learning target, but the learning target is independent of the category.

### CROSS-REFERENCE TO RELATED APPLICATIONS

This application is related to U.S. provisional patent application No. 61/124,755, entitled “Internet-based vocabulary learning system and methods,” filed on Apr. 21, 2008, the contents of which are incorporated herein by reference.

### TECHNICAL FIELD

The present disclosure is directed to user-directed, context-based learning systems and methods. More particularly, the present disclosure is directed to learning systems and methods that enable users to learn academic skills and concepts with context from their non-academic, real world interests.

### BACKGROUND

It is widely accepted that vocabulary knowledge is connected with success in schoolwork, test taking, college and job applications, professional work, and reading comprehension along with other literacies involved in effective communication. Spontaneous vocabulary learning is inherent in ongoing language and literacy development. However, it may not be sufficient for what an individual is attempting to do—the amount, level, and rate of vocabulary acquisition can vary significantly with situational demands as well as socioeconomic, cultural, and physiological differences. People of all ages and backgrounds find that they need to engage in explicit learning of new words and concepts at some point in their life in order to achieve their goals.

Intentional learning of new vocabulary proves daunting for many students. This can be significant for those who are struggling to learn because of disabilities, environmental challenges, language differences, and/or lack of engagement and discipline due to stress, past failures, or whatever reason they are not able to attend and retain. Even for those who consider themselves good students, building vocabulary can be intimidating, inaccessible, and uninteresting.

Learner-specific barriers to intentional vocabulary study are exacerbated by ineffective vocabulary learning programs. Many products or teaching methods fall short in providing pedagogical underpinnings recognized in practice and research as instrumental for effective vocabulary building and literacy development: 1) personally relevant content, 2) a study process that is engaging and disciplined, 3) opportunities for student input and ownership of their learning, and 4) adjustability in the materials and environment to meet individual learner needs and interests.

In short, if a vocabulary program does not provide learners with relevant content and an engaging as well as disciplined study process, along with the ability both to shape the content and activities with personal input and to adjust what, how, when they use them, then learning is in jeopardy. A shortfall in these pedagogical underpinnings negatively impacts the effectiveness of a vocabulary program at the initiation and during the course of study.

When one or more of the four above-mentioned pedagogical underpinnings are missing or ineffectively implemented, a student is more likely to mentally “opt out” of participating in the program. This is especially true for struggling learners who may have lower motivation and stamina due to past failures. Students' interest and attention must be captivated in the beginning and stimulated throughout in order to sustain practice, reinforcement, and application of the vocabulary they are studying. Repetitions are needed for a learner to gain the automaticity necessary for effective test taking and authentic use in communications. When a student's level of interest ebbs, so does their attention, and study benefits are not fully realized. To whatever degree a student approaches a vocabulary program with diminished enthusiasm and deliberation, their learning is diminished.

While impediments to learning vocabulary come from the learner and the vocabulary program, the onus is on the product to support all students in successful mastery. Following are common shortfalls of current vocabulary building programs.

1. The content is not personally relevant to the learner.
Vocabulary study is commonly presented as a task of memorizing lists of words and their definitions and/or translations. Some programs provide no meaning contexts. Others encourage students to create their own such as using the new words in sentences. Yet typically, these sentences provide only loose, if any, connections between the vocabulary and what is genuinely relevant to the student vis-à-vis their interests and life experience.

2. Study activities do not engage the students or discipline them in the tasks required for learning.
Practice activities are often provided to help with memorization and retention of new vocabulary. These are typically disciplined but dry (e.g., index cards, flash cards, rote memory study regime) or appealing but lacking in structure for monitoring learning (e.g., using vocabulary in cartoons, dialogues, games, puzzles, music and rhythms, dramatizations, multimedia creations). Also, while most programs highlight the importance of assessment, many do not build in an explicit progress evaluation and reporting component. In order for students to learn most effectively, the vocabulary product must engage them, and help them attend, practice, and monitor their understanding.

3. The program does not present opportunities for student input or support them in taking ownership of their learning.
One way that learners become invested in what they are doing, and in turn retain the vocabulary they are studying, is to place or use the words in some aspect of their lives. Few vocabulary products invite student input beyond the mundane strategy of making up sentence contexts for the new vocabulary words. They typically do not provide a range of choices for learners to select, embellish, or create their own meaning contexts that are personally relevant to them. Also vocabulary programs have not motivated students to own their learning such as by exchanging or publishing their work, or becoming contributors to the vocabulary program and its community. Students need spark and drive that is hard to get from standard dry, academic assignments.

4. The program is delivered as one size fits all without the capacity for individuals to customize and adjust parameters according to their needs, interests, styles, and abilities.
Vocabulary programs that offer comprehensive word lists, definitions, and meaning contexts are often highly structured, prescribing when and how the student interacts with the material. These rigid frameworks make it hard for learners to adjust the content or the activities so they can learn according to their interests, level, and learning style (unless they happen to match that of the vocabulary program). Too much material pushed to students in a closed or static system boxes them into a controlled experience that reduces relevance and active learning.
Other vocabulary programs that focus more on motivating learners are often light in systematic content or explicit scaffolds that support effective studying. Too little or too unstructured material in an open system saddles students with the responsibility of connecting what they are engaged in with disciplined study and practice, often without the competence to do so.
The typical product requires students to fit themselves into the program rather than the program being adjustable to fit the learner. This lack of flexibility and built-in settings adversely affects all learners especially those with challenges. Given the diversity of students, a vocabulary program's content, activities, pace, and deliverables need to be customizable and adjustable for individual learners.
New technologies provide unprecedented capacities for delivering, manipulating, and sharing vocabulary content. There is untapped opportunity for designing a digital environment that can capture and sustain the interest and attention of diverse learners for successful vocabulary learning.

Thus, in some aspects of the disclosure, it may be desirable to provide a system for giving individual and communities of users access to a plurality of vocabulary content, in disaggregated forms such as individual words and meaning contexts and aggregated forms such as vocabulary cards and vocabulary lists, through a network such as the Internet.

In various aspects of the disclosure, it may be desirable to enable words and their information to be presented to users in template formats such as vocabulary lists (VL) and vocabulary cards (VC). These may be dynamically constructed with the words, associated descriptors, and/or meaning context information in the vocabulary database.

In some aspects, it may be desirable to provide flexible search and browse navigation for finding and exploring vocabulary content. This may enable users to access words through multiple lenses based on cross-referenced categories and it allows filtering of results through defined categories as well as dynamically served tags that relate to the content selected. The results may include learning content such as program vocabulary lists (PVL), program vocabulary cards (PVC), user vocabulary lists (UVL), and user vocabulary cards (UVC).

According to various aspects, it may be desirable to provide users with individual work/play/communicate spaces (e.g., a web page for each registered user) that can be personalized and used as their “home base” for their vocabulary learning. This is a place where a user can collect PVL, PVC, UVL, and/or UVC content, study and practice it as is, or embellish. It is also a place where users can send and receive communications.

### SUMMARY OF THE INVENTION

According to various aspects of the disclosure, a user-directed, machine-implemented learning method may include presenting a plurality of selectable categories to a user, receiving an input from a user selecting one of the plurality of categories, and retrieving at least one data item with a learning target used in context in the data item. The data item corresponds to the selected category, and the use context explains the learning target, but the learning target is independent of the category.

In accordance with some aspects of the disclosure, a user-directed, machine-implemented learning system may include at least one processor, a memory including instructions for the processor, and a bus for providing communication between the processor and the memory. The memory may further include instructions for the processor, including instructions for presenting a plurality of selectable categories to a user, receiving an input from a user selecting one of the plurality of categories, and retrieving at least one data item with a learning target used in context in the data item. The data item corresponds to the selected category, and the use context explains the learning target, but the learning target is independent of the category.

According to some aspects of the disclosure, a tangible, machine-readable medium having instructions for at least one processor recorded thereon may comprise instructions for presenting a plurality of selectable categories to a user, instructions for receiving an input from a user selecting one of the plurality of categories, and instructions for retrieving at least one data item with a learning target used in context in the data item. The data item corresponds to the selected category and the use context explains the learning target, but the learning target is independent of the selected category.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a block diagram of a user-directed learning system in accordance with a possible embodiment of the disclosure;

FIG. 2 illustrates a block diagram of exemplary modules of a context-based learning engine in accordance with a possible embodiment of the disclosure;

FIG. 3 is a flowchart illustrating an exemplary user-directed learning process in accordance with one possible embodiment of the disclosure;

FIG. 4 is an exemplary screenshot associated with a user-directed learning system in accordance with one possible embodiment of the disclosure;

FIG. 5 is an exemplary screenshot associated with a user-directed learning system in accordance with one possible embodiment of the disclosure;

FIG. 6 is an exemplary screenshot associated with a user-directed learning system in accordance with one possible embodiment of the disclosure;

FIG. 7 is an exemplary screenshot associated with a user-directed learning system in accordance with one possible embodiment of the disclosure;

FIG. 8 is an exemplary screenshot associated with a user-directed learning system in accordance with one possible embodiment of the disclosure; and

FIG. 9 is an exemplary screenshot associated with a user-directed learning system in accordance with one possible embodiment of the disclosure.

### DETAILED DESCRIPTION

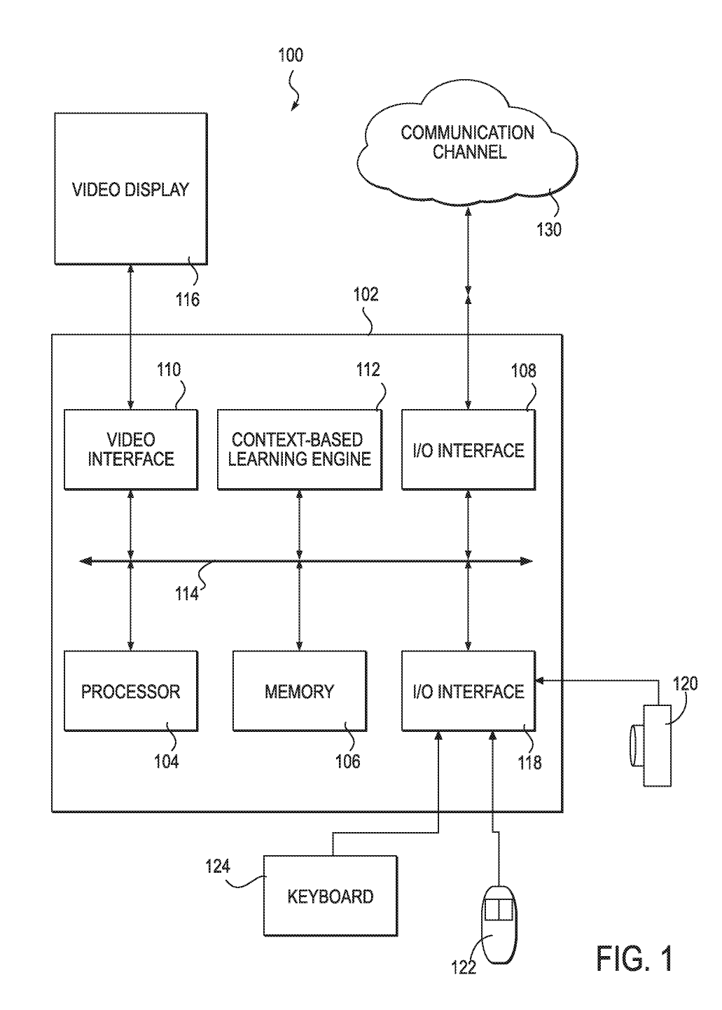

FIG. 1 illustrates a block diagram of an exemplary user-directed learning system 100 having a user-directed learning engine 112 in accordance with a possible embodiment of the disclosure. Various embodiments of the disclosure may be implemented using a computer 102, such as, for example, a general-purpose computer, as shown in FIG. 1.

The learning system 100 may include the computer 102, a video display 116, and input devices 122, 124. In addition, the learning system 100 can have any of a number of other output devices including line printers, laser printers, plotters, and other reproduction devices connected to the computer 102. The learning system 100 can be connected to one or more other computers via a communication interface 108 using an appropriate communication channel 130 such as a computer network, a modem communications path, or the like. The computer network may include a local area network (LAN), a wide area network (WAN), an Intranet, and/or the Internet.

The computer 102 may comprise a processor 104, a memory 106, input/output interfaces 108, 118, a video interface 110, a user-directed learning engine 112, and a bus 114. Bus 114 may permit communication among the components of the computer 102.

Processor 104 may include at least one conventional processor or microprocessor that interprets and executes instructions. Memory 106 may be a random access memory (RAM) or another type of dynamic storage device that stores information and instructions for execution by processor 104. Memory 106 may also include a read-only memory (ROM) which may include a conventional ROM device or another type of static storage device that stores static information and instructions for processor 104.

The video interface 110 is connected to the video display 116 and provides video signals from the computer 102 for display on the video display 116. User input to operate the computer 102 can be provided by one or more input devices 120, 122, 124 via the input/output interface 118. For example, an operator can use a keyboard 124, a pointing device such as a mouse 122, or a video device 120 to provide input to the computer 102.

The learning system 100 and computer 102 may perform such functions in response to processor 104 by executing sequences of instructions contained in a computer-readable medium, such as, for example, memory 106. Such instructions may be read into memory 106 from another computer-readable medium, such as for example a storage device associated with the system 100 and/or from a separate device via communication interface 108.

The learning system 100 and computer 102 illustrated in FIG. 1 and the related discussion are intended to provide a brief, general description of a suitable computing environment in which the invention may be implemented. Although not required, the invention will be described, at least in part, in the general context of computer-executable instructions, such as program modules, being executed by the learning system 100 and computer 102. Generally, program modules include routine programs, objects, components, data structures, etc. that perform particular tasks or implement particular abstract data types. Moreover, those skilled in the art will appreciate that other embodiments of the disclosure may be practiced in computer environments with many types of communication equipment and computer system configurations, including cellular devices, mobile communication devices, personal computers, hand-held devices, multi-processor systems, microprocessor-based or programmable consumer electronics, and the like.

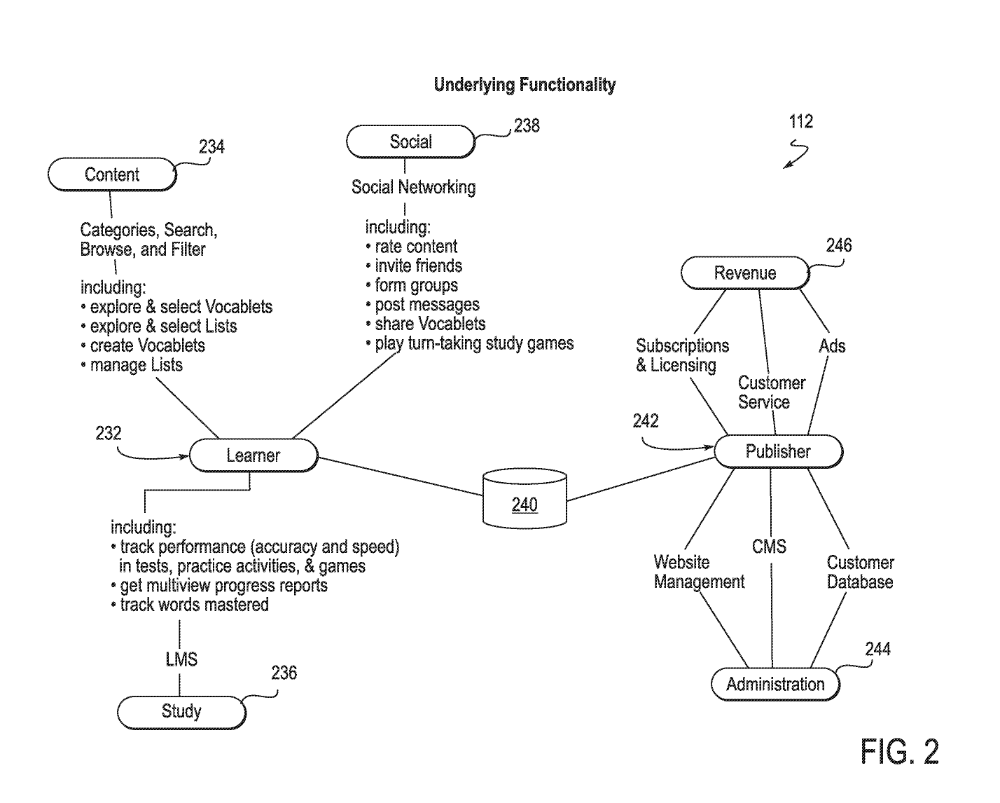

Referring now to FIG. 2, the block diagram illustrates exemplary modules of the context-based learning engine 112. As shown in FIG. 2, an exemplary context-based learning engine 112 may include a learner function 232 and a publisher function 242. The learner function 232 and/or the publisher function 242 may access a storage device 240, which may include for example, a vocabulary database and content management platform that deals with the input, storage, access, organization, and the like, of the program content created by the program publisher and also by users. The learner function 232 may include three platforms: a content platform 234, a study platform 236, and a social platform 238. The content platform 234 may include categories, search, browse, and filter functions. The study platform 236 may include performance tracking, for example, related to tests, practice activities, and games. The study platform 236 may also include a learning management system (LMS), which includes user data management, keeping track of registered users, their content, activities, assessment performance, what they have submitted, and the like. It may allow the assignment of roles to users giving them different types of access to and control over features/functionality. In turn, it may provide reports of user content, activity, and communication. The data may be stored for individual users and communities of users for their private use, group work, and public consumption. The social platform 238 includes social networking features such as inviting friends, forming groups, posting messages, sharing data items, and the like.

The publisher function 242 includes an administration platform 244 and a revenue platform 246. The administration platform 244 may include website management, a customer database, a content management system, a system for vetting user-contributed content, and an events management system.

The revenue platform 248 may include subscriptions/memberships, content licensing, customer service and training, advertising, sponsorships, conducting contests and other events, bundled distribution, and the like, as well as the potential for affiliate programs. In the setting of an internet-based system, the revenue platform 248 may include a number of e-commerce tools such as, for example, registration and purchasing options such as free registration, tiered for-fee sign-ups, ability to buy accessories for the data items, lists, and games, and/or accumulating “credits” or “currency” based on performance and/or activities and using the credits or currency to buy accessories, items, or membership. On the financial side, the system of the present disclosure integrates and a program currency that users may use in the exchange of vocabulary content and activities. It also integrates advertising and sponsorships and.

According to various aspects of the disclosure, the program publisher may identify key sets of skills or concepts to include in the program's content collection based on use cases for the product such as test prep, school coursework, professional training, personal advancement, etc. Then searches may be made to find the skills or concepts used meaningfully in non-academic, real-world contexts. In addition to the non-academic, real-world context(s), the publisher may gather skill and concept descriptors and real-world context descriptors. The skills and concepts, their meaning and explanatory contexts, and their descriptors are tagged and cross referenced in multiple categories and subcategories drawing from non-academic, real-world arenas, and also school topics, standardized tests, job requirements, for example.

For illustrative purposes, exemplary learning processes of the context-based learning engine 112 will be described below in relation to the block diagrams shown in FIGS. 1 and 2.

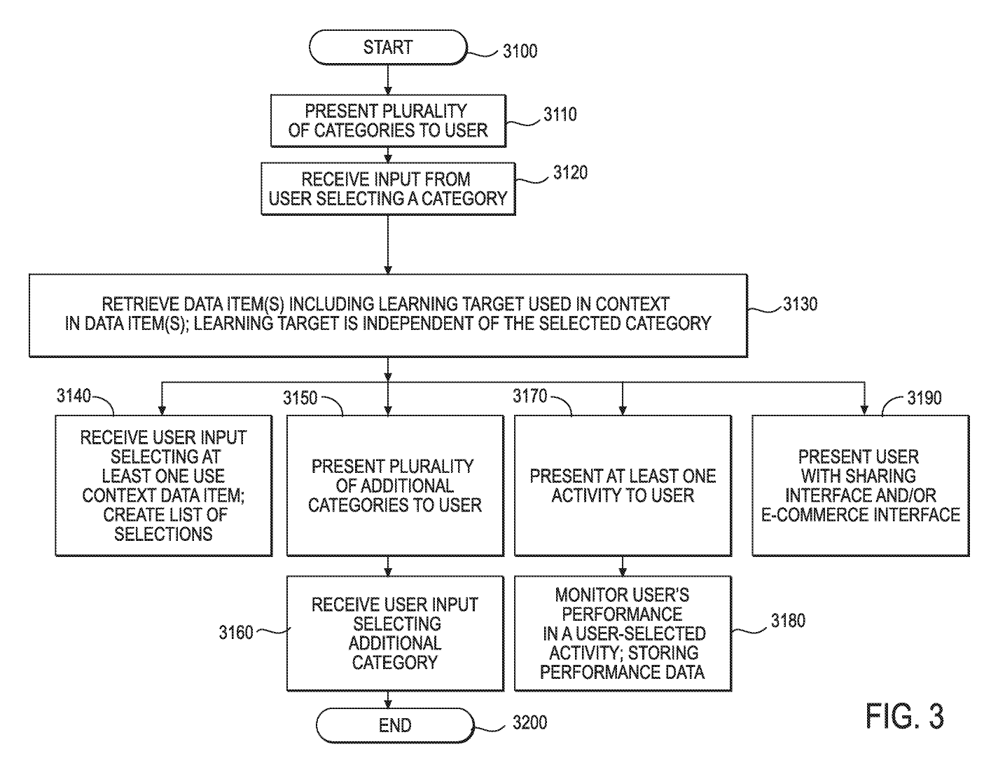

FIG. 3 is an exemplary flowchart illustrating some of the basic steps associated with a user-directed learning process in accordance with a possible embodiment of the disclosure. The process begins at step 3100, for example, when a user logs in to the learning system 100. Control continues to step 3110 where the system 100 presents a plurality of selectable categories to a user. Control then proceeds to step 3120.

In step 3120, the system receives an input from a user selecting one category from the plurality of categories. According to some aspects, the categories may comprise non-academic, real world categories such as, for example, pop culture categories. The pop culture categories may include music, movies, televisions, sports, celebrities, or the like. Control proceeds to step 3130 where the system 100 retrieves at least one data item with a learning target used in context in the data item. The data item corresponds to the selected category and the use context explains the learning target. However, the learning target is independent of said category. In one exemplary aspect, the selected category may be music and the use context may comprise song lyrics that include the learning target. Control may then proceed to any one of steps 3140, 3150, 3170, or 3190, depending on the direction desired and selected by the user. The system 100 presents the user with the option to select any one of these steps.

According to some aspects, in step 3140, the system 100 may receive a user input selecting at least one use context data item and create a list of one or more user selections. The list may then be saved, shared, modified, etc.

In step 3150, the system 100 may present an additional plurality of categories to the user. Control then continues to step 3160 where the system receives a user input selecting one of the additional categories. In response to this user selection, the system 100 may retrieve additional data items associated with the learning target that may be related to and/or dependent on the learning target.

In step 3170, the system 100 may present one or more activities such as practice games and/or learning exercises to the user. Control then continues to step 3180 where the system monitors the user's performance in a user-selected activity. Data reflective of the user's performance and/or progress may be stored for continued monitoring.

In step 3190, the system 100 may present the user with a sharing interface and/or an e-commerce interface. The sharing interface may allow the user to access social networking features such as inviting friends, forming groups, posting messages, sharing data items, and the like. The sharable data items may include comments, rating, lists, etc. related to learning targets. The e-commerce interface may allow the user to register with the system, purchase options, access tiered for-fee sign-ups, buy accessories for the data items, lists, and games, and/or accumulate “credits” or “currency” based on performance and/or activities and use the credits or currency to buy accessories, items, or membership.

At any time, control may proceed to step 3500 where the process ends. The end step may occur whenever a user logs off from the system 100.

It should be appreciated that in actuality, the learning system 100 may be implemented on a computer platform that is non-linear, rather than the linear model shown in FIG. 3. In some aspects, the system 100 may be implemented, for example, via Web 2.0, which provides a very integrated architecture. With such an integrated architecture, for example, the user may proceed directly to any of steps 3140, 3150, 3170, 3180, 3190 upon login (step 3100) without having to step linearly through the progression of steps 3110 to 3130.

In various aspects of the disclosure, it may be desirable to enable words and their information to be presented to users in template formats such as vocabulary lists (VL) and vocabulary cards (VC). These may be dynamically constructed with the words, associated descriptors, and/or meaning context information in the vocabulary database.

“Program vocabulary lists” (PVL) and “program vocabulary cards” (PVC) are constructed from program publisher content. Further, as described in method 2 below, users can identify words that are not in the program's vocabulary collection, supplying meaning context and/or descriptive information for them. In this case, they begin with an empty VL or VC template to create a new “user vocabulary list” (UVL) or “user vocabulary card” (UVC). Users can also customize an existing PVL, PVC, UVL, or UVC, adding and/or embellishing meaning contexts and descriptive information for words that are already in the program collection, to create an additional UVL or UVC. Users can choose to keep their new or customized UVL or UVC for their own private use (My VL, My VC), for group use (Group VL, Group VC), and/or submit it into the program's vocabulary collection. Program identified experts may vet the user-submitted vocabulary list or card (UVL-V, UVC-V) or the user-submitted content may remain in the collection as a non-vetted vocabulary list or card (UVL-NV, UVC-NV).

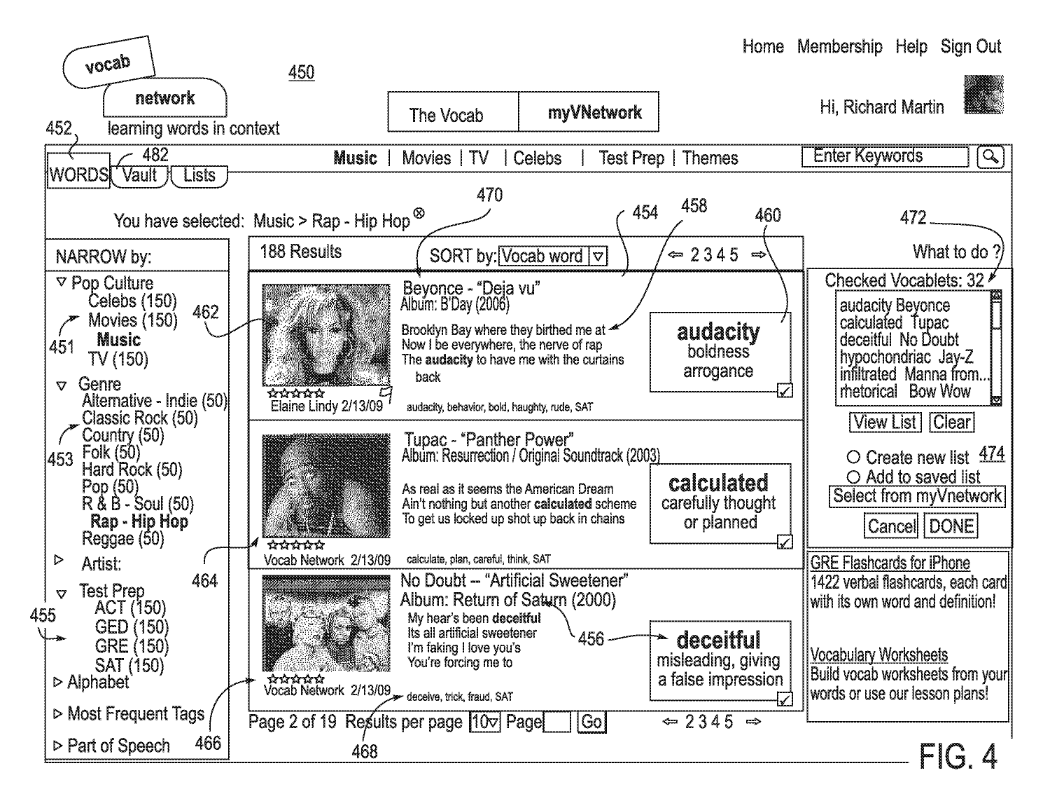

FIGS. 4-9 illustrate exemplary aspects of the disclosure where a learning target 456 of the disclosed learning systems and methods may comprise a vocabulary word. According to various aspects of the disclosure, the program publisher may identify key sets of words to include in the program's vocabulary collection based on use cases for the product such as test prep for the SAT or GRE, school coursework, English language learning, etc. Then searches may be made to find the words used meaningfully in popular culture contexts such as song lyrics, movie transcripts, celebrity blogs, and the like. In addition to the meaning context(s), the publisher may gather word descriptors (e.g., definitions, parts of speech, pronunciations, word families) and popular culture context descriptors (e.g., the performer's name, song title, album title, link to related web pages). The words, their meaning contexts, and their descriptors are tagged and cross referenced in multiple categories and subcategories drawing from popular culture, and also school topics, standardized tests, second language learning, age/grade levels, for example.

Referring now to FIG. 4, an exemplary screenshot 450 associated with a user-directed learning system of the disclosure is illustrated. The screenshot 450 is representative of an exemplary initial page viewed by members/users after logging into the Vocab Network. This screenshot 450 may sometimes be referred to as “The Vocab” page.

As evident from the upper left corner of the screenshot 450, the “WORDS” tab 452 of The Vocab page has been selected in FIG. 4. The WORDS tab 452 is associated with a cluster of data items associated with a database of vocabulary words. The “VAULT” tab 482 is associated with a cluster of data items associated with the database of vocabulary words. The data items accessible via the VAULT tab 482 are similar to those accessible via the WORDS tab, except that those associated with the VAULT tab may include mature and/or objectionable (e.g., explicit) subject matter. On the left side of the screenshot 450, a user may select a category 451 and/or a sub-category 453 from which data items may be retrieved. Moreover, the user may select from a further plurality of categories and/or subcategories 455 listed below the categories 451 and sub-categories 453.

In the middle of the screenshot 450, a plurality of data items 454 corresponding to the selected category 451 and/or sub-category 453 are displayed. According to some aspects, the data items 454 may be referred to as Vocablets. The data items 454 may include a learning target 456, a use context 458 that includes the learning target, a learning target box 460, a photo 462, a rating 464 of the data item 454, user information 466, tags 468, and/or data item identification information 470. According to some aspects, the learning target 456 may comprise a vocabulary word, the use context 458 may include song lyrics, the learning target box 460 may include additional information relating to the vocabulary word, the photo 462 may depict a musician(s) associated with the lyric, the tags 468 may include synonyms, related words, categories, etc. of the learning target 456, and the identification information 470 may include the musician's name, the song title, the album title, or the like related to the lyrics. The rating 464 and/or comment trails (not shown) associated with the data items 454 may be populated via the sharing function of the social platform 238 of the context-based learning engine 112 of the disclosure. The tags 468 may be automatically generated by the context-based learning engine 112 or user-generated.

Learning targets may be drawn from common school subjects such as science, mathematics, history, geography, language arts, literature . . . and fields such as politics, religion, economics, the environment, and the arts. One such embodiment may involve learning targets organized around principles of mathematics such as decimals or percentage calculations. In such an embodiment, the data items, including one or more data items that describe tipping at a restaurant, may correspond t a non-academic, real world selectable category of “restaurants” or “dining.”

The right side of the screenshot 450 may include a first window 472 including a list of checked data items 454, such as for example, Vocablets. According to some aspects, the items may be added to the list 472 by selecting the learning target box 460 or some other region associated with the desired data item 454 to be added to the list. According to some aspects, a second window 474 may include options to create a new list of data items or to add data items to a saved list.

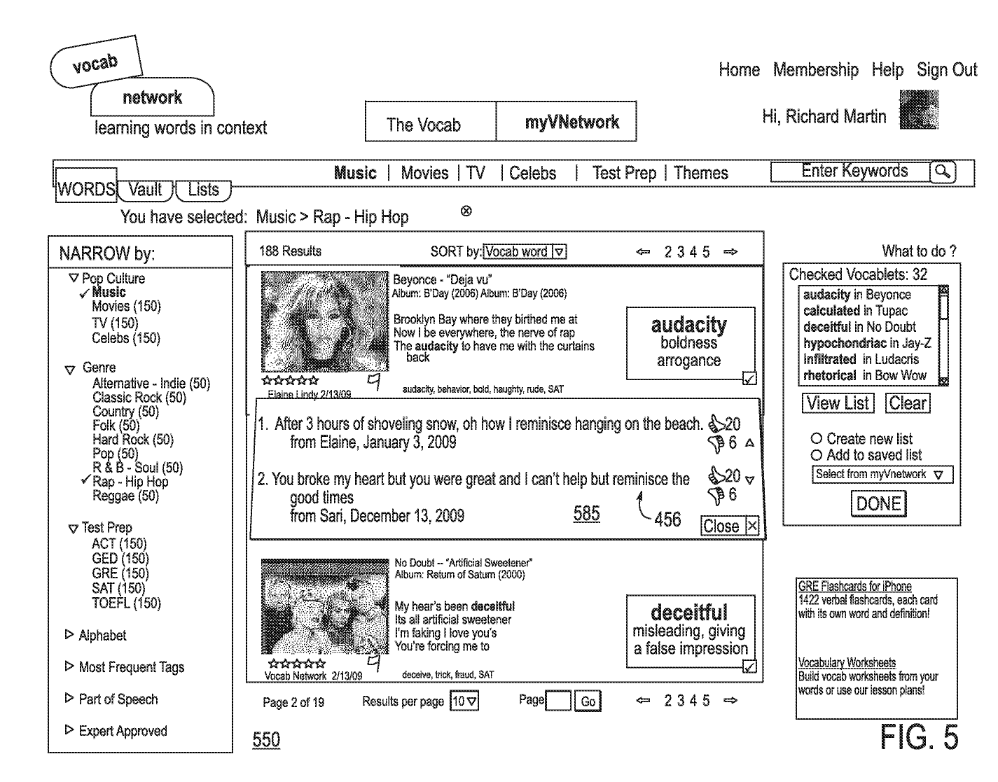

Referring now to FIG. 5, an exemplary screenshot 550 similar to screenshot 450 and associated with a user-directed learning system of the disclosure is illustrated. In the screenshot 550, a window 585 is activated to present an otherwise hidden display of exemplary usages of a learning target 456. For example, according to some aspects, where the learning target 456 is a vocabulary word, the exemplary usage shown in the window 585 may be one or more sentences in which the word is used. The information in the window 585 may be part of the corresponding data item for the learning target 456.

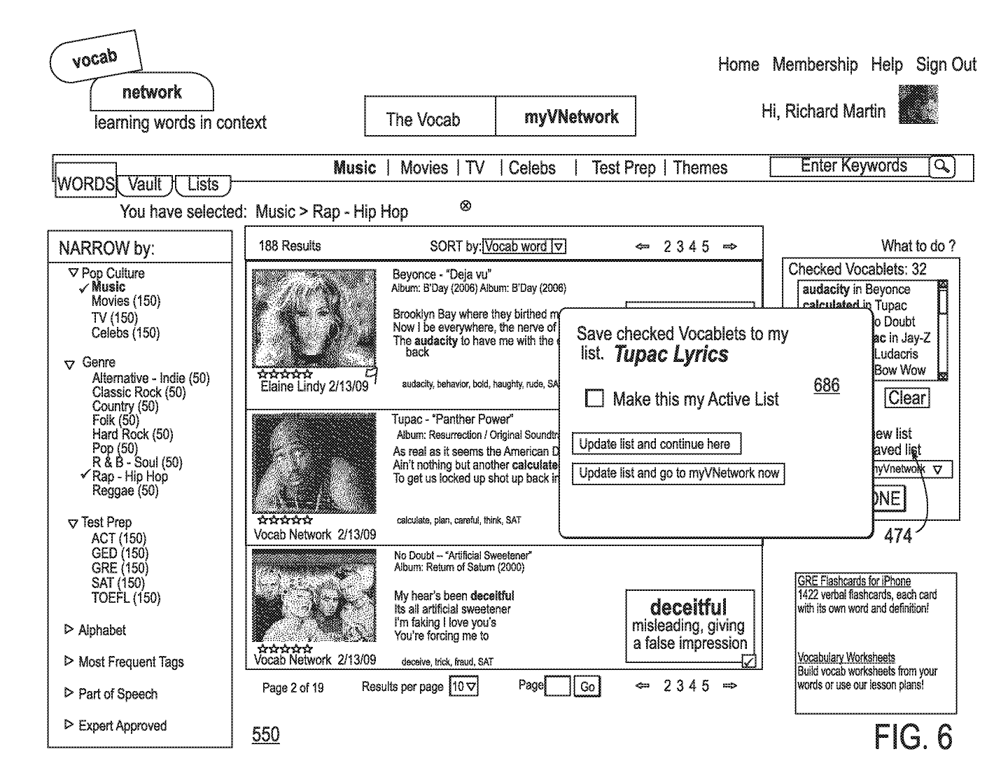

FIG. 6 is an exemplary screenshot 650 similar to screenshots 450, 550 and associated with a user-directed learning system of the disclosure. In the screenshot 650, a window 686 is activated for example when a user selects one of the options to create a new list of data items or to add data items to a saved list via the second window 474.

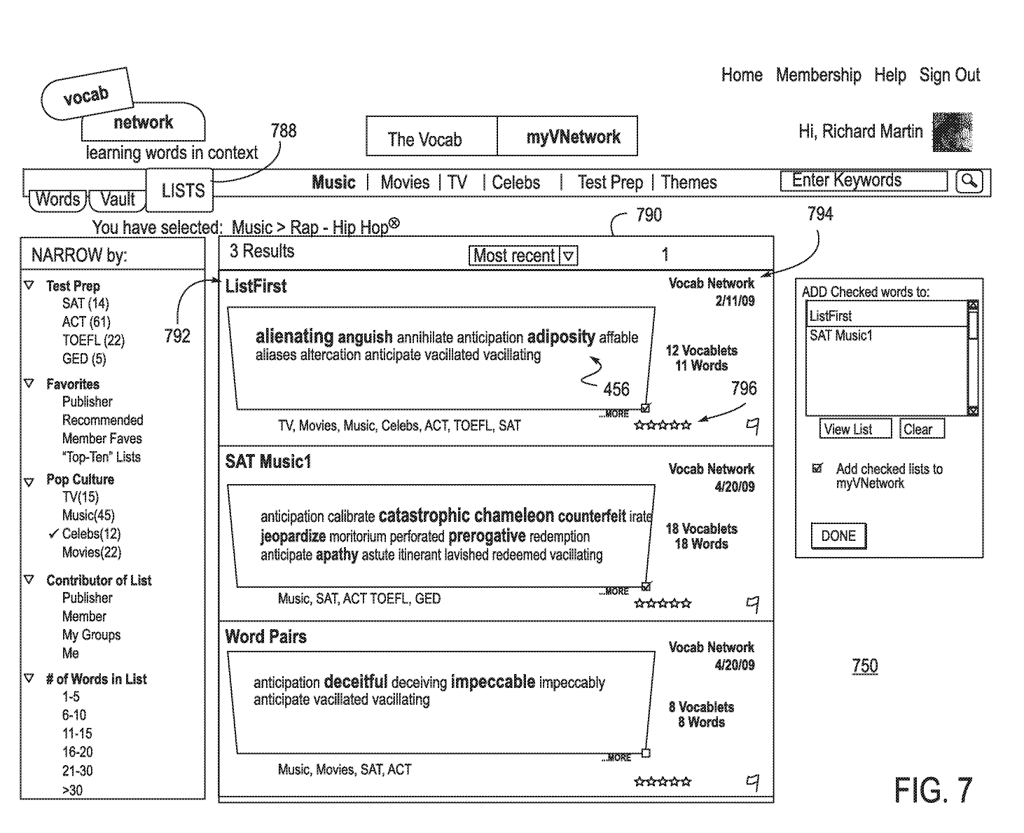

Referring now to FIG. 7, an exemplary screenshot 750 is shown. As evident from the upper left corner of the screenshot 750, the “LISTS” tab 788 of the Vocab Page has been selected in FIG. 7. The LISTS tab 788 is associated with a cluster of lists 790 associated with a database of vocabulary words. As shown, the middle of the screenshot 750 displays a plurality of lists 790. Each list 790 may include a list title 792, list information 794, rating information 796, and one or more learning targets 456. From the lists 790, a user can access the data items 454, for example, Vocablets, associated with each learning target 456.

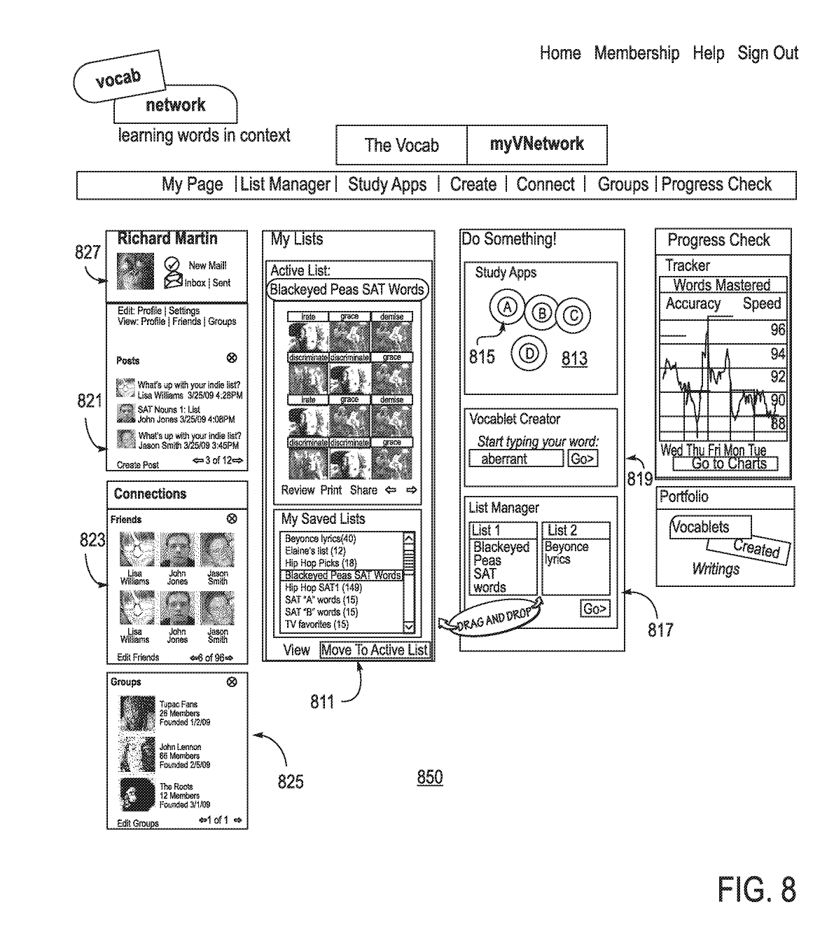

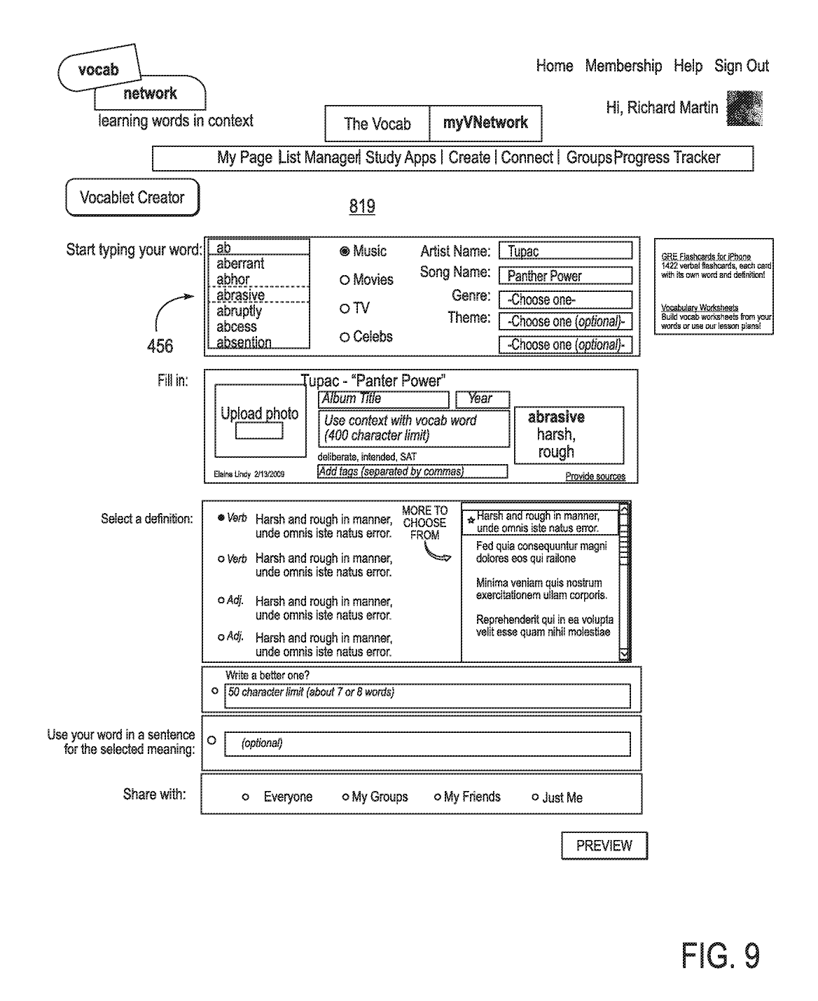

FIGS. 8 and 9 illustrate the “myVNetwork” aspects of the exemplary learning systems and methods of the present disclosure. Referring to an exemplary screenshot 850 as shown in FIG. 8, a personalized myVNetwork page may include a window 811 including the user's selected lists. The window 811 may display the lists with graphics and/or with text. A second window 813 of the screenshot 850 may provide access to one or more study applications 815, sometimes referred to as Study Apps. In some aspects, the Study Apps 815 may include activities, exercises, and/or practice games designed to facilitate learning, memorization, studying, playing, writing, and reviewing of learning targets. In one aspect, the practice games may include crossword puzzles, hangman, matching games, timed fill-ins, and the like. Practice games may be played by one user or among more than one user or among groups of users. The games can be played on-line and may be synchronous or asynchronous. The Study Apps 815 may be provided with a timer, a comparison function, and/or a scorekeeping function. As shown to the right side of screenshot 850, the context-based learning engine 112 may be provided with one or more facility to monitor a user's progress.

The second window 813 may also provide a list manager 817 and/or a data item creator 819, such as for example, a Vocablet creator. The data item creator 819 may provide the user with a mechanism for adding new data items, for example, a use context or the like. In some aspects, the new data items may be limited to words that are already contained in the database of the context-based learning engine 112. An exemplary Vocablet creator is shown in FIG. 9. The Vocablet creator may allow a user to submit a new use context (e.g., song lyrics) for a learning target (e.g., a vocabulary word). The data item creator 819 may provide functionality for searching to determine whether the learning target of the desired new content is already included in the system 100. Such a determination may include a determination as to whether a new learning target is a related form of a current learning target. For example, in the case of a Vocablet creator as the data item creator 819 and a vocabulary word as the learning target 456, the system 100 may be arranged to convert an inflected form of the word and/or a derivationally-related form of the word to its anchor. The system 100 then seeks a match for the anchor in the system database, for example, storage device 240. It should be appreciated that in some aspects, the system 100 may be arranged to seek a match for the inflected form or derivationally-related form of the word. According to some aspects, learning targets outside the system may be rejected. For a word that matches a learning target 456 in the system 100, the system connects the vocabulary word to a particular word meaning. This linkage serves to connect all vocabulary words with a particular word meaning so that learners can access all Vocablets that exemplify a particular word meaning of a given vocabulary word. The list manager 817 may provide the user with a mechanism for adding new data items, deleting data items, renaming a list, combining data items from multiple lists into a new list, or otherwise modifying the data items in any existing list.

The left side of the screenshot 850 may include a plurality of windows 821, 823, 825, 827 pertaining to a social networking function of the present disclosure. For example, window 821 provides the user with access to posts, for example, email or text messages, sent to the user. Window 823 provides the user with a list of and links to personal connection, such as for example, persons who have accepted invitations from the user. Window 825 provides the user with a list of and links to member of groups to which the user may have subscribed. Window 827 provides a user identification, as well as links to various personal preferences associated with the user's profile and identification.

In a first use of the disclosed systems and methods, users access and explore vocabulary content by browsing and selecting vocabulary words through multiple means. Users can enter what they are looking for in a search box and/or browse through categories, subcategories, and tags. They can narrow their browse/search results using a selection of browse categories and tags. They can also focus on pre-selected lists and different ways to sort words. Lists can include user-submitted groupings (e.g., SAT words that have hip hop meaning contexts), special topics, top 10 hardest, etc. Word sorts can include most popular, most viewed, most likely to be on the test, etc. Means of narrowing as well as focusing search and browse results, such as with filters, tags, lists, and sorts, allow learners to adjust the scope of their vocabulary study to a size that feels manageable and concentrate on that which is personally motivating.

The four pedagogical underpinnings are incorporated in the first use. The Internet provides the program word contexts and uses in many non-academic, real world forms and genres, for example, popular culture, providing learners a wide selection of engaging content. Unlike an individual teacher, the Internet can provide a broad enough selection of genres, categories and choices to enable a learner to quickly locate and select a topic of particular personal interest. Learners choose an area of particular personal interest and so doing make their vocabulary study personally relevant. The personal relevance of selected content maximizes the learner's attention level, and a maximized attention level directed at the content provides additional time for the learner to learn the content. The selection process itself requires individual thought and input. And the result, a study list having a length that feels manageable, shapes the task to a scale that matches the user's interests and abilities.

In a second use of the disclosed systems and methods, the program builds on the ease of creating personal online pages to provide users individual spaces. From a personal online page, a user can manipulate the content of the public program collection. This is where users can create their own “vocabulary cards” either by starting from an empty vocabulary card template or, from a PVC with the content “open,” meaning the information can be changed and deleted, other elements added, the appearance customized and the like: e.g., user vocabulary cards “UVC”; where users can save, organize and personalize vocabulary cards into a list: e.g., user vocabulary lists “UVL” for further study or personal interest; users can access any vocabulary card or list previously saved; where users can practice and review vocabulary words using assessment tools and practice games; and where users can evaluate learning progress using one or multiple tools. Online creativity tools make learning by doing easier than ever; they are accessible in users' individual spaces.

The four pedagogical underpinnings are also incorporated in the second use. The user works with a body of vocabulary content with non-academic, real world contexts, for example, popular culture, selected because the references were engaging and personally relevant. The user has the opportunity to imprint the vocabulary content with personal style and pizzazz. Study tools are available through practice games and other assessment devices that can assist the user by providing feedback on learning progress. Opportunities to apply word knowledge in creative writing activities help to reinforce world knowledge. In addition, writing opportunities offer sharing opportunities where learners can share personal writing samples with friends, groups, or to all users/members and where other persons may comment on or rate the sample privately or in the public forum. The scale and scope of the customizing activities and assessment practices matches the interests and abilities of the user.

In a third use of the disclosed systems and methods, users share and communicate vocabulary content by exchanging, rating, reviewing, playing games with other learners, and the like, through social media and social networking. An example of an opportunity to share is to publish an embellished vocabulary card online for others to view and/or rate. Users may also earn points or gain levels by contributing embellished vocabulary cards and/or by receiving favorable ratings, and those points or levels are viewable for others to see.

The four pedagogical underpinnings are also incorporated in the third use. Users select which activities involving sharing and exchanging of vocabulary content hold most interest and personal relevance. Opportunities for individual input permeate the world of social media; whether a user is rating another user's UVC, posting a message on another user's personal page, or earning points by contributing UVC's and UVL's to the program, the activity draws on an individual's energy and creativity while reinforcing the learning value from exposure to vocabulary words and their respective meanings. Scalability is also inherent in the world of social media, since by definition the user selects which activity to engage in and to what extent.

In summary, the three methods of the present disclosure, separately or interconnectedly, contain the four pedagogical underpinnings. Thus, the user's interest is engaged and sustained throughout the course of the present invention.

Embodiments within the scope of the present disclosure may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

It will be apparent to those skilled in the art that various modifications and variations can be made in the devices and methods of the present disclosure without departing from the scope of the invention. Other embodiments of the invention will be apparent to those skilled in the art from consideration of the specification and practice of the invention disclosed herein. It is intended that the specification and examples be considered as exemplary only.

What is claimed is:

1. A user-directed, machine-implemented learning method, the method comprising:
presenting a plurality of selectable categories to a user;
receiving an input from a user selecting one of said plurality of categories; and
retrieving at least one data item with a learning target used in context in the data item, said data item corresponding to the selected category and said use context explaining the learning target, said learning target being independent of said category.

2. The method of claim 1, further comprising:
receiving an input from the user selecting at least one of said use context data items; and
creating a user-specific list of said selected use context data items.

3. The method of claim 1, further comprising:
presenting an additional plurality of selectable categories to a user;
receiving an input from a user selecting one of said additional plurality of categories; and
retrieving at least one data item with a learning target used in context in the data item, said data item and said learning target corresponding to the selected category and said use context explaining the learning target.

4. The method of claim 1, further comprising:
receiving a proposed use context from the user for addition to a database;
determining whether the use context includes one of a learning target and a form of a learning target already stored in the database; and,
where the one of a learning target and a form of a learning target is determined to be already stored in the database, adding the proposed use context to the database.

5. The method of claim 1, further comprising:
presenting at least one activity to the user, said at least one activity being designed to assist the user in learning the learning target;
monitoring the user's performance in said at least one activity with respect to the learning target; and
storing data reflective of the user's performance in relation to the learning target.

6. The method of claim 1, further comprising at least one of:
presenting the user with an interface for sharing personalized information with other users; and
presenting the user with an e-commerce interface for accessing one or more components of the machine-implement learning method.

7. A user-directed, machine-implemented learning system, the system comprising:
at least one processor;
a memory including instructions for the processor, the memory further comprising instructions for presenting a plurality of selectable categories to a user; receiving an input from a user selecting one of said plurality of categories; and retrieving at least one data item with a learning target used in context in the data item, said data item corresponding to the selected category and said use context explaining the learning target, said learning target being independent of said category; and
a bus for providing communication between the processor and the memory.

8. The system of claim 7, wherein the memory further comprises instructions for receiving an input from the user selecting at least one of said use context data items; and creating a user-specific list of said selected use context data items.

9. The system of claim 7, wherein each said data item further includes educational descriptive data associated with the learning target.

10. The system of claim 9, wherein the educational descriptive data comprises linguistic data.

11. The system of claim 7, wherein the memory further comprises instructions for presenting an additional plurality of selectable categories to a user; receiving an input from a user selecting one of said additional plurality of categories; and retrieving at least one data item with a learning target used in context in the data item, said data item corresponding to the selected category and said use context explaining the learning target, said learning target being independent of said category.

12. The system of claim 7, wherein said learning target comprises one of a skill and a concept.

13. The system of claim 12, wherein the learning target comprises a vocabulary word.

14. The system of claim 7, wherein the memory further comprises instructions for receiving a proposed use context from the user for addition to a database; determining whether the use context includes one of a learning target and a form of a learning target already stored in the database; and, where the one of a learning target and a form of a learning target is determined to be already stored in the database, adding the proposed use context to the database.

15. The system of claim 7, wherein the memory further comprises:
instructions for presenting at least one activity to the user, said at least one activity being designed to assist the user in learning the learning target;
instructions for monitoring the user's performance in said at least one activity with respect to the learning target; and
instructions for storing data reflective of the user's performance in relation to the learning target.

16. The system of claim 7, wherein the memory further comprises instructions for presenting the user with an interface for sharing personalized information with other users.

17. The system of claim 7, wherein the memory further comprises instructions for presenting the user with an e-commerce interface for accessing one or more components of the machine-implement learning method.

18. The system of claim 7, wherein the learning target comprises one of a plurality of predetermined learning targets.

19. The system of claim 7, wherein the learning target comprises a dynamically-determined learning target.

20. A tangible, machine-readable medium having instructions for at least one processor recorded thereon, the medium comprising:
instructions for presenting a plurality of selectable categories to a user;
instructions for receiving an input from a user selecting one of said plurality of categories; and
instructions for retrieving at least one data item with a learning target used in context in the data item, said data item corresponding to the selected category and said use context explaining the learning target, said learning target being independent of said category.
